(19) United States
(12) Patent Application Publication
(10) Pub. No.: US 2020/0256208 A1
(43) Pub. Date: Aug. 13, 2020

(54) A METHOD FOR CLEANING A TURBOFAN ENGINE AND APPARATUS FOR USE THEREOF

(71) Applicant: AIIS SOLUTIONS SDN. BHD., Kuala Lumpur (MY)

(72) Inventor: Muhamad Shahril SHAHBUDIN, Kuala Lumpur (MY)

(73) Assignee: AIIS SOLUTIONS SDN. BHD., Kuala Lumpur (MY)

(21) Appl. No.: 15/759,006

(22) PCT Filed: Sep. 6, 2016
(86) PCT No.: PCT/MY2016/050055

§ 371 Date: Mar. 9, 2018

(30) Foreign Application Priority Data
Sep. 11, 2015 (MY) 2015703168

(51) Int. Cl. F01D 25/00; F02B 77/04; B24C 1/00; B24C 3/32

(52) U.S. Cl. CPC F01D 25/002; F02B 77/04; B08B 9/032; B24C 3/327; B24C 1/003

(57) ABSTRACT

A method and apparatus for cleaning a turbofan engine by use of dry ice pellets and a plurality of nozzles. The method comprises steps of setting up the emitting device, activating the turbofan engine, initiating the emitting device for cleaning the turbofan engine, halting the turbofan engine and repeating the steps for various settings and parameters. The apparatus comprises an emitting device, a plurality of nozzles, a conduit means, and a clamp.

### CROSS REFERENCE TO RELATED APPLICATIONS

This application is a National Stage of International Application No. PCT/MY2016/050055, filed on Sep. 6, 2016, which claims priority from Malaysian Patent Application No. PI 2015703168, filed on Sep. 11, 2015.

### TECHNICAL FIELD OF THE INVENTION

The invention relates to a method for cleaning a turbofan engine and an apparatus for use thereof. More particularly, a method and apparatus for cleaning the compressor of the turbofan engine.

### BACKGROUND OF THE INVENTION

A turbofan engine is a gas turbine engine. A gas turbofan engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

In order to maximise operating efficiency and minimise carbon build-up in the turbofan engine, periodic cleaning of the turbofan engine is necessary. Although the turbofan engine works most efficiently at very high temperatures, the periodic cleaning of the turbofan engine is best done at room temperature. Cleaning of the turbofan engine herein does not refer to cosmetic cleaning of the engine exterior but instead the cleaning process applied to the interior components of the turbofan engine.

In addition, contamination of the turbofan engine by impurities such as insects, dust, dirt, etc causes rotation instability to the turbofan engine blades, consequently reducing compressor performance which substantially reduces the efficiency and power output of the turbofan engine. Further, there is an increase in the consumption of fuel required for creating thrust, causing an increased thermic load on main components within the turbofan engine. The result is shortening of the lifespan of the turbofan engine, rise in fuel consumption and an increase in emission of CO₂, NOₓ and other greenhouse gases.

Generally, cleaning of the turbofan engine involves use of water with detergents or certain solvents flowed through the engine to clean the turbine blades and the turbofan engine core. Traditionally, in order to carry out cleaning process of the turbofan engine, the engine has to be removed from the aeroplane, then applying cleaning mixtures during the engine overhaul. Naturally, such a procedure is undesirable due to the time and cost involved. Subsequently, as technology advances, cleaning of the engine on the wing of the aeroplane became feasible. The turbofan engine is first initiated, wherein the blades are rotated at low revolutions and the fluid sprayed at the suction end of the turbofan engine and flows through to the exhaust end of the turbofan engine. Conventional cleaning methods are not as effective because the denser cleaning mixture is partially centrifuged out into the bypass fan duct and therefore does not reach into critical gas-path components.

Another drawback of the conventional cleaning method using liquids was that the liquid lacked sufficient scrubbing action. Therefore, the method involved injecting a solid material into the engine such as ground pecan shells or corn cobs were implemented. However, the use of such materials did not solve the problem as significant damage were noticeable at the compressor blade surfaces and seals. Furthermore, these solid materials become stuck in the core of the turbofan engine, creating obstructions to rotation of the blades of the turbofan engine.

Fuel used in turbofan engine are often contaminated with sulfur, that when burned at high temperatures, emits sodium sulfate gas which causes sulfidation. Sulfidation is accelerated when the aeroplane operates near oceans, industrial complexes, cities, or volcanic regions. Sulfidation is a corrosive process that erodes the surfaces of compressor blades. Although at present, there is no way of eliminating sulfidation, periodic cleaning of the turbofan engine has been proven to reduce and delay the sulfidation.

In view of the abovementioned shortcomings, several apparatuses and methods have been developed to provide improved ways of cleaning a turbofan engine and specifically an aeroplane jet engine.

U.S. Pat. No. 8,109,807 B2 discloses an apparatus for cleaning a jet engine using solid carbon dioxide. The apparatus further comprises at least two nozzles, which are flat in structure that rotates along with the engine to enlarge the spray area. The nozzles are design to directly in tact with fan section and the low pressure compressor (LPC) section which define the weaknesses of the processes. Also, the solid carbon dioxide used for the cleaning process mentioned herein disperses towards the turbofan and the low pressure compressor (LPC), but they do not effectively clean the blades in the high pressure compressor (HPC).

U.S. Pat. No. 7,815,743 B2 discloses a method for cleaning a turbofan engine comprising a plurality of nozzles arranged to atomize cleaning liquid in the air stream in an air inlet of the engine up-stream of a fan of the engine. The setup of the plurality of nozzles in a specific position and angle allows for more effective cleaning of the turbofan engine. However, the abovementioned nozzle setup is directed at the engine up-stream and does not effectively clean the entire turbofan engine sections.

### SUMMARY OF THE PRESENT INVENTION

According to the present invention, described is a method for cleaning a turbofan engine comprising the steps of setting up at least an emitting device with at least a conduit for directing the flow of cleaning substances, activating the turbofan engine, initiating the emitting device for cleaning process of the turbofan engine and halting the turbofan engine and the emitting device. The method is characterized by the step of connecting at least a nozzle to the conduit for discharging the cleaning substances towards inner parts of the turbofan engine, in which the nozzle comprises a detachable tip, connector plug and a coupling means for connection to the conduit.

The present invention further relates to an apparatus for cleaning a turbofan engine, comprising at least an emitting device for providing cleaning substances and at least a conduit for directing the flow of cleaning substances from the emitting device. The conduit is connected to at least a nozzle for discharging the cleaning substances towards the inner parts of the turbofan engine, in which the nozzle comprises a detachable tip, for connection to the conduit, capable of cleaning the inner parts of the turbofan engine.

It is an object of the present invention to provide a method and apparatus for cleaning a turbofan engine that is able to reduce fuel consumption of aeroplanes. It should be understood that the cleaner the turbofan engine, or more specifically the cleaner the high pressure compressor (HPC), the greater the mechanical energy output will be to generate power and reduce chemical energy consumption.

It is yet an object of the present invention to provide a method and apparatus for cleaning a turbofan engine that is able to clean the turbofan engine blades and to remove baked effect of the turbine blades due to the combustion processes.

It is a further object of the present invention to provide a method and apparatus for cleaning a turbofan engine that delays the deterioration period of the turbofan engine.

It is another object of the present invention to provide a method and apparatus for cleaning a turbofan engine that is capable of cleaning the blades of the turbofan engine at the High Pressure Compressor (HPC) section.

It is further another object of the present invention to provide a method and apparatus for cleaning a turbofan engine using dry ice pellets.

It is yet further another object of the present invention to provide a method and apparatus for cleaning a turbofan engine that is environmentally friendly as the dry ice pellets sublimes and leaves no secondary waste after the cleaning processes.

### BRIEF DESCRIPTION OF THE DRAWINGS

FIG. 1 illustrates a turbofan engine showing the location of variable bleed valve (VBV) door according to the present invention.

FIG. 2 illustrates a variable bleed valve (VBV) nozzle for inserting into the variable bleed valve (VBV) door pathway according to the present invention.

FIG. 3 illustrates a British Standard Institution (BSI) nozzle for inserting into the borescope port high pressure compressor (HPC).

FIG. 4 illustrates a flowchart for a method for cleaning a turbofan engine according to the present invention.

FIG. 5 illustrates a flowchart for a method for setting up the emitting device with the conduit according to the present invention.

### DETAILED DESCRIPTION OF THE PREFERRED EMBODIMENTS

The abovementioned and other features and objects of this invention will become more apparent and better understood by reference to the following detailed description. It should be understood that the detailed description made known below is not intended to be exhaustive or limit the invention to the precise form disclosed as the invention may assume various alternative forms. All the relevant modifications and alterations made to the present invention as covered in the detailed description should be construed to fall within the scope of the appended claims. Therefore, the configuration of the invention is not limited to the configuration mentioned in the following description.

The present invention relates to a method and apparatus for cleaning a turbofan engine (100), more preferably a turbofan engine of an aeroplane. Common examples of a turbofan engine (100) are CFM56-5B4/3, CFM56-5B4/P, CFM56-5B46/P, CFM56-5B6/3, CFM Leap-1a26, Rolls-Royce Trent 700 and Rolls-Royce Trent 772b. It should be understood by the skilled addressee that these are just examples of turbofan engines and the present invention should not be limited to the use of these turbofan engines. As earlier described, a turbofan engine (100) comprises a fan blade, a low pressure compressor, LPC, a high pressure compressor (HPC), a combustion chamber, a high pressure turbine and a low pressure turbine. The method and apparatus for cleaning a turbofan engine (100) of the present invention herein described is focused at the HPC section of the turbofan engine. The cleaning substances are discharged to the HPC of the turbofan engine by means of a nozzle (200, 300).

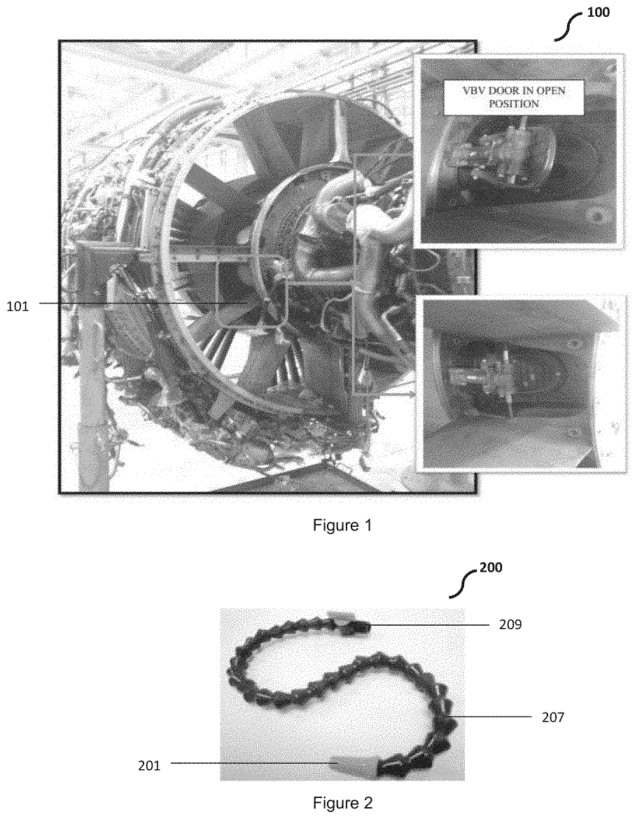

Referring to FIG. 1, the variable bleed valve (VBV) is located after the low pressure compressor and at the start of the high pressure compressor. There is a variable bleed valve (VBV) door (101) for inspection and maintenance purposes. The high pressure compressor section comprises a number of blades attached to a shaft. A borescope or similarly a boroscope is an optical device comprising rigid or flexible tube with an eyepiece on one end and is used for visual inspection work of the turbofan engine (100) where the area to be inspected is inaccessible by other means. The high pressure compressor (HPC) comprises a plurality of borescope ports wherein the borescope may be inserted for inspection. There are a number of borescope ports at the high pressure compressor (HPC) that has been categorized by stages, and the number varies depending on the engine models and their engine makers.

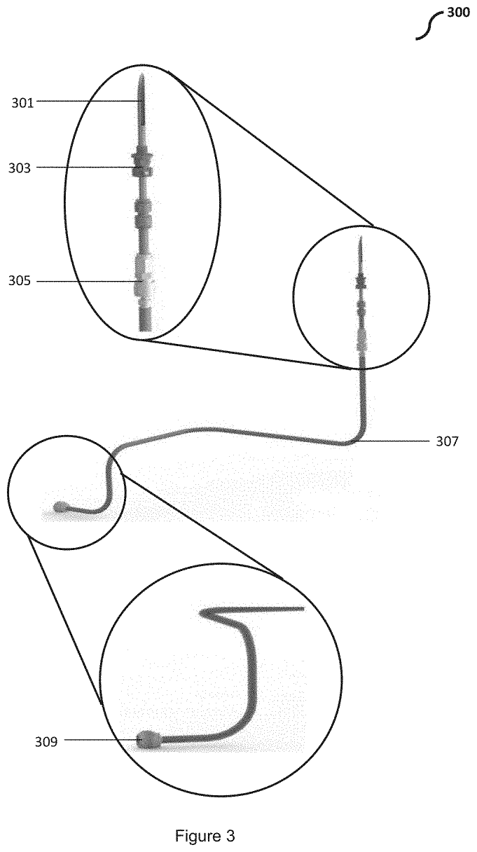

Referring now to FIGS. 2 and 3, illustrated are preferred embodiments of nozzles (200, 300) of the apparatus for cleaning a turbofan engine (100) according to the present invention. The present invention describes an apparatus for cleaning a turbofan engine comprising at least an emitting device for providing cleaning substances and at least a conduit for directing the flow of cleaning substances form the emitting device. It is noted that the conduit is connected to at least a nozzle (200, 300) for discharging the cleaning substances towards the turbofan engine (100), in which the nozzle (200, 300) comprises a detachable tip (301) attached to a connector plug and a coupling means for connection to the conduit. The nozzle (200, 300) is capable of cleaning the inner parts of the turbofan engine (100). The inner parts of the turbofan engine are referring to any one or a combination of low pressure compressor (LPC) and high pressure compressor (HPC).

The emitting device of the present invention is also known as a blasting device, whereby cleaning substance is inserted into and blasted by the emitting device for cleaning the turbofan engine. The cleaning substances are dry ice, more preferably dry ice in pellets form. The dry ice used for cleaning the turbofan engine have dimensions of less than 3 mm, more preferably dimensions of less than 0.5 mm. The emitting device comprises a scrambler for slicing dry ice. The scrambler is custom made based on the specification required for the cleaning of the turbofan engine. Smaller dimensions of dry ice gives improved cleaning properties. As the dry ice impacts the engine turbine blades, the dry ice removes the contaminations from the blades and sublimes, leaving behind no residue. The emitting device can be controlled and run remotely after the nozzles (200, 300) are set up at the correct locations. There is a setting on the remote control for which manual blast can be switched to automatic blasts.

As there are a few processes to be executed for the cleaning of the turbofan engine (100), there are two main types of nozzles (200, 300) that are being used throughout the cleaning processes, the first nozzle operated at the variable bleed valve (VBV) door (101) pathway, herein now referred to as variable bleed valve (VBV) nozzles (200) and the second nozzle operated at the borescope port high pressure compressor (HPC), herein now referred to as BSI nozzles (300). There is a conduit means connected to the emitting device and at the same time the variable bleed valve (VBV) nozzles (200) or the BSI nozzles (300) are connected to the conduit through the rear tip (209, 309) of the nozzle.

FIG. 2 illustrates the first nozzle (200) for discharging the cleaning substances that will be inserted through the variable bleed valve (VBV) door (101) of the high pressure compressor (HPC). In order for the variable bleed valve (VBV) nozzle (200) to be inserted through the variable bleed valve (VBV) door (101) for discharge of the cleaning substances, at least a clamp is used to hold and support the variable bleed valve (VBV) nozzle (200) to the turbofan engine (100) bracket. In one of the embodiment of the invention, the clamp acts as a lock to maintain the position of the nozzle. In addition, the variable bleed valve (VBV) nozzle (200) for discharging the dry ice further comprises a flexible rotatable solid conduit (207) enabling a multi-directional flow of the cleaning substance. Optionally, the conduit can be in a fixed design instead of being flexible depending on the model of the turbofan engine. When the turbofan engine (100) is initiated and the cleaning substance discharged, the air pressure will push the dry ice through the high pressure compressor (HPC) and cleans the blades through its paths.

FIG. 3 illustrates the second nozzle (300) for discharging the cleaning substances is inserted through the boroscope port of the high pressure compressor (HPC). In order to achieve better cleaning results, the BSI nozzles (300) are inserted through a number of borescope port high pressure compressor (HPC) and if required, the BSI nozzles (300) are inserted through all the borescope port of the HPC and the cleaning substance are blasted simultaneously. The BSI nozzles (300) comprises a rear tip (309), a coupling means (305), a one touch fitting, a connector plug (303) and an detachable tip (301). The connector plug (303) comprises a screw for adjusting and replacement of the tip (301). The rear tip (309) is for connection to the conduit means of the emitting device. It should be noted that the at least a nozzle (200, 300) has pre-determined indication showing the nozzle direction as well as labels to indicate the length. The BSI nozzle (300) is designed based on the diameter, thread size of the boroscope port and length of the blades of the turbofan engine.

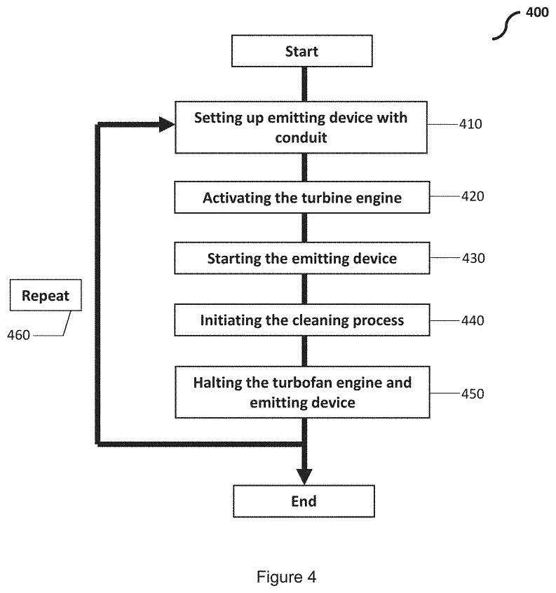

Referring to FIG. 4, illustrated are steps (400) of cleaning a turbofan engine (100) according to the present invention. The method comprises the steps of setting up at least an emitting device with at least a conduit for directing the flow of cleaning substances, activating the turbofan engine (100), initiating the emitting device for cleaning process of the turbofan engine (100), and halting the turbofan engine (100) and the emitting device. The abovementioned steps are then repeated for various settings (460). The method is characterized by the step of connecting at least a nozzle (200, 300) to the conduit for cleaning the inner parts of the turbofan engine (100) by discharging cleaning substances towards the turbofan engine (100) in which the nozzle (200,300) comprises a detachable tip (301), a connector plug (303) and a coupling means (305) for connection to the conduit and said at least a nozzle (200, 300) is configured for cleaning inner parts of the turbofan engine (100). The at least a nozzle (200, 300) discharges cleaning substances to the HPC of the turbofan engine. The inner parts of the turbofan engine (100) comprise any one or a combination of low pressure compressor (LPC) and high pressure compressor (HPC).

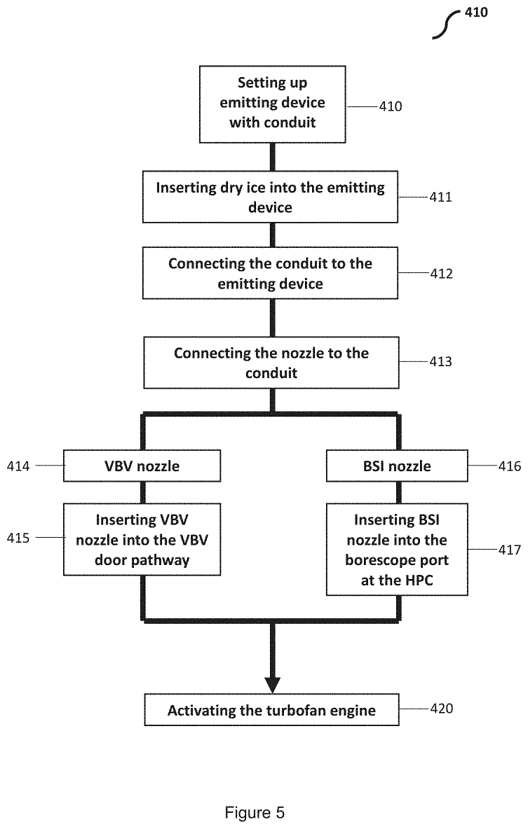

FIG. 5 illustrated are steps (410) of setting up the emitting device with the conduit for cleaning of the turbofan engine (100) according to the present invention. There are two main procedures for the cleaning of the turbofan engine (100), one is the cleaning operation at the variable bleed valve (VBV) door (101) pathway (415) and the other is the cleaning operation at the boroscope ports at the high pressure compressor (HPC) (417). For the cleaning operation at the variable bleed valve (VBV) door (101) pathway, the steps begin with the setting up the emitting device and inserting dry ice into the emitting device. The emitting device, also known as a blasting machine, is connected to at least a conduit means and a first nozzle (200) is connected to the conduit means (412). The conduit means herein may be referred to as a dry ice (or more particularly a solid form of CO₂) hose, whereas the nozzle may be referred to as variable bleed valve (VBV) nozzle (200) which is the first nozzle (200). The variable bleed valve (VBV) nozzle (200) is inserted into the variable bleed valve (VBV) door (101) of the high pressure compressor (HPC) of the turbofan engine before the cleaning process begins. Thereafter, a clamp attached to the turbofan engine (100) bracket beam is used to support the variable bleed valve (VBV) nozzle (200) in place, and inserting a first nozzle (200) for discharging the cleaning substances through the variable bleed valve (VBV) door (101) of the high pressure compressor (HPC). Dry ice is inserted or poured into the emitting device (411). The amount of dry ice inserted or poured into the emitting device is in the range of 5 to 15 kg in weight, more preferably 10 kg in weight. The turbofan engine (100) is then initiated at revolutions per minute, rpm, preferably in the range of 10 to 20 rpm, more preferably 15 rpm (420). The emitting device is then turned on for a few minutes (440), in the period of 2 to 4 minutes, preferably 3 minutes. As the emitting device is turned on, the dry ice will be sprayed onto the turbofan engine (100). The dry ice hits the engine turbine parts and blades and cleans the dirt and particles off from the blades, then sublimes without leaving behind residues. The emitting device is then turned off, turbofan engine (100) switched off (450), clamp dismantled and variable bleed valve (VBV) nozzle (200) removed from the conduit means.

The cleaning operation at the borescope port high pressure compressor (HPC) (417) is carried out after the cleaning operation at the variable bleed valve (VBV) pathway and involves using of different nozzles, herein referred to as BSI nozzles (300), for different borescope port high pressure compressor (HPC) stages. The dimensions and sizes of the BSI nozzles (300) varies depending on the model of the turbofan engine.

Upon commencement of the cleaning operation at the borescope port high pressure compressor (HPC), the second nozzle (300) or also known as the BSI nozzle (300) is connected to the conduit means (413, 416). A first BSI nozzle (300) is inserted into the stage 1 (STG1) boroscope port (417). The first BSI nozzle (300) is aligned to face a suction side of the blade of the high pressure compressor (HPC). Dry ice is inserted or poured into the emitting device (411) and the second nozzle (300) is inserted for discharging the cleaning substances through boroscope ports of the high pressure compressor (HPC). The emitting device is also commonly known as a hopper. The amount of dry ice inserted into the emitting device is in the range of 3 to 7 kg in weight, more preferably 5 kg in weight. The turbofan engine (100) is then initiated at revolutions per minute, rpm, preferably in the range of 10 to 20 rpm, more preferably 15 rpm (420). The emitting device is then turned on for a few minutes (440), in the period of 1 to 3 minutes, preferably 2 minutes. As the emitting device is turned on, the dry ice will be sprayed onto the turbofan engine (100), for cleaning the blades of the turbofan engine (100). The emitting device is then turned off, and the turbofan engine (100) is switched off (450). A second BSI nozzle (300) is then aligned to face subsequent blades of the high pressure compressor (HPC). The cleaning process is then repeated (460). To repeat the process for further cleaning, a third BSI nozzle is inserted into the stage 3 (STG3) boroscope port and a further BSI nozzle is inserted into a further stage of boroscope port. By implementing the repeating steps, each surface of the multi stages blades, vanes, and inner casing of the high pressure compressor (HPC) will be thoroughly cleaned.

The preferred embodiment of the present invention as described in the foregoing description is an apparatus for cleaning a turbofan engine (100) comprising at least an emitting device for providing cleaning substances, and at least a conduit for directing the flow of cleaning substances from the emitting device, characterized in that the conduit is connected to at least a nozzle (200, 300) for discharging the cleaning substances towards the inner parts of the turbofan engine (100), in which the nozzle (200, 300) comprises a detachable tip (301), for connection to the conduit, capable of cleaning the inner parts of the turbofan engine (100), and said at least a nozzle (200, 300) is configured for cleaning inner parts of the turbofan engine through at least a boroscope port of said turbofan engine (100) by blasting the cleaning substances via said at least an emitting device.

The inner parts of the turbofan engine refer to any one or a combination of low pressure compressor (LPC) and high pressure compressor (HPC). The detachable tip (301) of the nozzle (200, 300) is attached to a connector plug (303) and a coupling means (305) for connection to the conduit. The connector plug (303) is adjustable for replacement of the detachable tip (301), and said at least a nozzle (200, 300) discharges cleaning substances to the high pressure compressor (HPC) of the turbofan engine (100). Said at least a nozzle is a first nozzle (200) inserted through the variable bleed valve (VBV) door (101) for discharging the cleaning substances into the high pressure compressor (HPC).

Said at least a nozzle is a second nozzle (300) inserted through the boroscope port for discharging the cleaning substances into the high pressure compressor, (HPC). The apparatus further comprises a clamp that is attached to the turbofan engine (100) bracket for supporting the nozzle (200). The cleaning substances are dry ice in the form of pellets form. The dry ice pellets have dimensions of less than 0.5 mm or less than 3 mm. The emitting device further comprises a scrambler for slicing the dry ice into pellets form. The emitting device is operated automatically through a remote control.

The invention described herein is susceptible to variations, modifications and/or additions other than those specifically described and it is to be understood that the invention includes all such variations, modifications and/or additions which fall within the scope of the following claims.

1-28. (canceled)

29. A method for cleaning a turbofan engine (100), comprising the steps of:
setting up at least an emitting device with at least a conduit for directing the flow of cleaning substances;
activating the turbofan engine;
initiating the emitting device for cleaning process of the turbofan engine; and
halting the turbofan engine and the emitting device;
the method is characterized by the step of connecting at least a nozzle (200,300) to the conduit for discharging the cleaning substances towards inner parts of the turbofan engine, in which the at least a nozzle comprises a detachable tip (301), connector plug (303) and a coupling means (305) for connection to the conduit and said at least a nozzle is configured for cleaning inner parts of the turbofan engine through at least a boroscope port of said turbofan engine by blasting the cleaning substances via said at least an emitting device.

30. The method of claim 29, wherein the inner parts of the turbofan engine comprise any one or a combination of low pressure compressor and high pressure compressor.

31. The method of claim 30, wherein the step of setting up at least an emitting device with at least a conduit further comprising the steps of:
inserting dry ice into the emitting device;
supporting the at least a nozzle by means of a clamp attached to the turbofan engine bracket; and
inserting a first nozzle for discharging the cleaning substances through a variable bleed valve door of the high pressure compressor.

32. The method of claim 31, wherein the weight of dry ice inserted into the emitting device is in the range of 5 to 15 kg.

33. The method of claim 32, wherein the weight of dry ice inserted into the emitting device is preferably 10 kg.

34. The method of claim 29, wherein the turbofan engine (100) is activated at revolutions per minute, rpm, in the range of 10 to 20 rpm.

35. The method of claim 34, wherein the turbofan engine is activated at rpm of preferably 15 rpm.

36. The method of claim 29, wherein the emitting device is initiated for a period of time of 2 to 4 minutes for cleaning the turbofan engine.

37. The method of claim 36, wherein the emitting device is initiated for a period of time, preferably 3 minutes for cleaning the turbofan engine.

38. The method of claim 30, wherein the step of setting up at least an emitting device with at least a conduit further comprising the steps of:
inserting dry ice into the emitting device; and
inserting a second nozzle for discharging the cleaning substances through boroscope ports of the high pressure compressor.

39. The method of claim 38, wherein the weight of dry ice inserted into the emitting device is in the range of 3 to 7 kg.

40. The method of claim 39, wherein the weight of dry ice inserted into the emitting device is preferably 5 kg.

41. The method of claim 29, wherein the emitting device is initiated for a period of time of 1 to 3 minutes for cleaning the turbofan engine.

42. The method of claim 41, wherein the emitting device is initiated for a period of time, preferably 2 minutes for cleaning the turbofan engine.

43. An apparatus for cleaning a turbofan engine (100), comprising:
at least an emitting device for providing cleaning substances; and
at least a conduit for directing the flow of cleaning substances from the emitting device;
wherein the conduit is connected to at least a nozzle (200, 300) for discharging the cleaning substances towards the inner parts of the turbofan engine, in which the at least a nozzle comprises a detachable tip (301), for connection to the conduit, capable of cleaning the inner parts of the turbofan engine, and said at least a nozzle is configured for cleaning inner parts of the turbofan engine through at least a boroscope port of said turbofan engine by blasting the cleaning substances via said at least an emitting device.

44. The apparatus of claim 43, wherein the inner parts of the turbofan engine comprise any one or a combination of low pressure compressor and high pressure compressor.

45. The apparatus of claim 44, wherein the detachable tip (301) is attached to a connector plug (303) and a coupling means (305) for connection to the conduit.

46. The apparatus of claim 45, wherein the connector plug (303) is adjustable for replacement of the detachable tip (301).

47. The apparatus of claim 43, wherein the at least a nozzle discharges cleaning substances to the high pressure compressor of the turbofan engine.

48. The apparatus of claim 43, wherein the at least a nozzle is a first nozzle (200) inserted through a variable bleed valve door for discharging the cleaning substances into the high pressure compressor.

49. The apparatus of claim 43, wherein the at least a nozzle is a second nozzle (300) inserted through the boroscope port for discharging the cleaning substances into the high pressure compressor.

50. The apparatus of claim 43, wherein the apparatus further comprises a clamp that is attached to the turbofan engine bracket for supporting the at least a nozzle.

51. The apparatus of claim 43, wherein the cleaning substances are dry ice.

52. The apparatus of claim 51, wherein the dry ice are in pellets form.

53. The apparatus of claim 52, wherein the dry ice pellets have dimensions of less than 3 mm.

54. The apparatus of claim 53, wherein the dry ice pellets have dimensions of less than 0.5 mm.

55. The apparatus of claim 43, wherein the emitting device further comprises a scrambler for slicing the dry ice into pellets form.

56. The apparatus of claim 43, wherein the emitting device is operated automatically through a remote control.
